(19) United States
(12) Patent Application Publication
(10) Pub. No.: US 2007/0155399 A1
(43) Pub. Date: Jul. 5, 2007

(54) Devices and methods for synchronizing location information in an access point

(76) Inventors: William P. Alberth JR., Prairie Grove, IL (US); Daniel J. Declerck, Lake Barrington, IL (US); William E. Welnick, Poway, CA (US)

Correspondence Address: MOTOROLA INC, 600 NORTH US HIGHWAY 45, ROOM AS437, LIBERTYVILLE, IL, 60048-5343, US

(21) Appl. No.: 11/321,309

(22) Filed: Dec. 29, 2005

(51) Int. Cl. H04Q 7/20

(52) U.S. Cl. 455/456.1

(57) ABSTRACT

Disclosed are methods of synchronizing, by a mobile station, location information between a plurality of networks of different types. A method includes entering into the coverage area of a first access point of a first network by-the mobile station, the first access point having associated location information including a first location value. The method also includes determining a second location value, in conjunction with a second network, and communicating location information between the first access point and the mobile station, including receiving the first location value from the first access point by the mobile station. The method further includes determining if the second location value is within a predetermined tolerance of the first location value. If the second location value is within the predetermined tolerance, the method also includes using the location information associated with the first access point for one or more emergency assistance services.

### FIELD

The present disclosure relates to synchronization of location information between wireless devices in a network, and more particularly to synchronizing location information between an access point and a mobile station.

### BACKGROUND

Wireless Local Area Networks (WLANs) are becoming compatible with many different types of products. While businesses originally installed WLANs so that desktop computers could be used on networks without expensive wiring, the functionality of the WLANs has evolved to allow mobile communication devices, such as wireless telephones, laptop computers, personal digital assistants (PDAs) and digital cameras to connect to WLANs for Internet access and wireless Voice over Internet Protocol (VoIP) telephone service.

Short for wireless fidelity, WI-FI is a trademark for sets of product compatibility standards for WLANs. WI-FI certified products are interoperable with each other even if they are from different manufacturers. A WI-FI enabled device is able to connect to a WLAN when near one of the network's wireless access points (WAPs or APs).

The connection between an access point and a WI-FI enabled device is made by radio signals in a frequency band of, for example 2.4 GHz for WI-FI devices conforming to the 802.11b or 802.11g standards, and 5 GHz for WI-FI devices conforming to the 802.11a standard. The access points can be in any configuration. For example, a typical corporate use of an access point includes attaching it to a wired network. Within the range of an access point, a wireless end-user has a full network connection with the benefit of mobility. In this instance, the access point can operate as a gateway for users to access the wired network. If the WLAN is connected to the Internet, the WI-Fl enabled device can have Internet access as well, including VoIP if available. The geographic region covered by one or more access points is called a hot spot. The range of access points can vary as can the distance between them.

Manufacturers of mobile communication devices such as cellular telephones are WI-FI enabling the devices so that when a user roams into a hot spot, a telephone can switch its communication protocol from that of a more expensive cellular carrier connection to a less expensive WI-FI communication connection. In indoor situations, a switch to a WI-FI protocol from a cellular network may be additionally beneficial since a cellular network can lose its signal strength indoors while a WLAN may have a stronger signal within a hot spot.

While cost effective, the access points of WLANs traditionally do not have independent means for self determining their location. Access point devices may be purchased off the shelf and installed so that they are connected either wirelessly or by wires to a network. The access point then becomes a relay between a communication device, such as a cellular telephone or other mobile station, and the network. Unlike the wired communication of landline-based telephone service, there is generally no substantially trustworthy location information associated with an access point. Some manufactures provide means for voluntary location loading into the access points or a manner in which to create a location database. However, the accuracy and timeliness of the data may be suspect.

On the other hand, cellular technology includes independent means for self determining the location of a mobile station. For example, some cellular handsets are global positioning system (GPS) enabled. Also, cellular providers may use triangulation and time differentials to generate a location fix for a cellular handset. One benefit of self location determination may be realized when a call is placed to an emergency assistance service from the mobile station over a cellular network, for example, to a public safety access point (PSAP). In such a circumstance, the emergency assistance service can learn from the mobile station the location from which the emergency call was placed so that first responders may respond to the correct location. Cellular providers enable self determination of the location of the mobile station and that location information can be accessed by caller identification at the PSAP. However, cellular service is not always available, particularly inside buildings and outside of service areas.

The benefits of emergency assistance through cellular providers may not be easily available in WLAN networks. This is because, in many instances, there may be no substantially reliable means for location self-determination. In view of the increasing popularity of WI-FI for VoIP, the Federal Communications Commission (FCC) has attempted to close this gap between the services available through WIFI voice communication connections and the services available through cellular and landline voice conmunication connections by enacting a ruling that requires Internet telephone carriers, such as those accessed through WLANs, to provide full 911 emergency assistance services. As part of providing full 911 emergency assistance services, the WLANs will need to be able to provide reasonably reliable location information.

Some manufacturers offer GPS in their WI-FI enabled devices so that their devices may be location self-aware. However, GPS works best in open areas where signals have a direct path to the satellite and does not work well in areas where there is no line-of-sight to the satellite. For example, a user may roam with a device into a basement where a GPS signal is weak or inaccessible, defeating the purpose of adding, GPS to resolve the emergency assistance network availability requirement.

It would be beneficial were an access point to be location self-aware so that when a user's wireless mobile device roams into its geographical boundary, the access point could deliver its location with some certainty to the WI-FI enabled device.

### BRIEF DESCRIPTION OF THE DRAWINGS

FIG. 1 depicts three access points having coverage areas including geographic boundaries, and a mobile station roaming between the coverage areas;

FIG. 2 depicts a mobile station 108 and some of its components to carry out the methods in accordance with this disclosure;

FIG. 3 is a combination signal diagram and flow chart to illustrate communication between and operations of at least one mobile station and one or more access points and a network provider; and

FIG. 4 illustrates a plurality of mobile stations entering into the coverage area of an access point.

### DETAILED DESCRIPTION

Disclosed are methods of synchronizing location information between a plurality of networks of different types. The plurality of networks can include a first network such as a WLAN including a first access point having a coverage area that can have geographical boundaries. The location information for the first access point can have an associated first location value.

The plurality of networks can include a second network such as a cellular network or GPS network. One or more mobile stations, such as cellular telephones, may be adapted for communicating with both the first network and the second network. The location information for the mobile station can have a second location value that is associated with the second network.

The mobile station can enter into the coverage area of a first access point. To synchronize location information between the mobile station and the access point, the access point can communicate location information including the first location value to the mobile station. The mobile station can then determine if the second location value is within a predetermined tolerance of the first location value. If the second location value is within the predetermined tolerance of the first location value, then the location information associated with the first access point can be used for one or more emergency assistance services.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

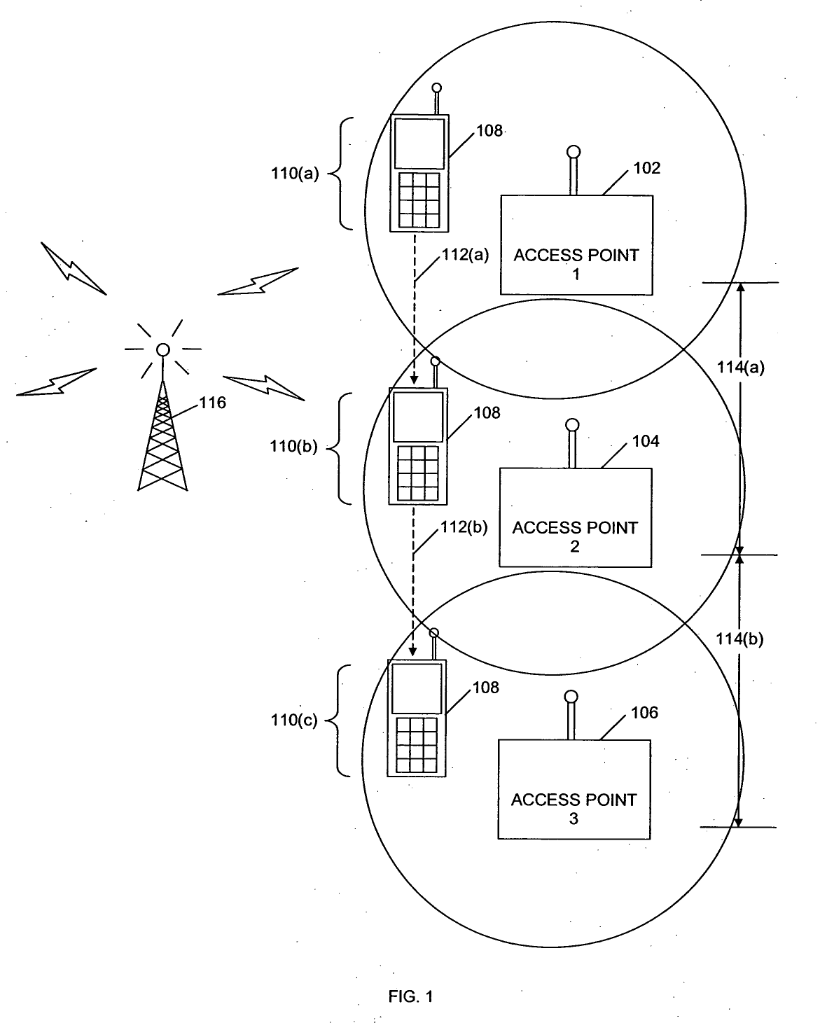

FIG. 1 shows three access points having geographic boundaries, and a mobile station roaming therebetween. While the access points 102, 104 and 106 are shown in a linear arrangement, other configurations are available. For example, a lily pad network configuration can provide hot spots where a mobile station can connect to the Internet for surfing or VoIP without regard for the particular networks to which they have attached for the moment. For example, a combination of coffeehouses, libraries, and other public spaces offering wireless access allow mobile stations to roam over a large area (like hopping from lily-pad to lily-pad), staying more-or-less continuously connected. It is understood that any type of WLAN or access point configuration is within the scope of this discussion.

FIG. 1 further shows a first mobile station 108 in a first position 110(a). The mobile station 108 may be a wireless communication device, and in particular, a cellular telephone. The mobile station represents a wide variety of mobile communication devices that have been developed for use within various networks. Such handheld communication devices can include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include the capability of transferring high content data. For example, the mobile station 108 can provide Internet access, multi-media content access and/or VoIP.

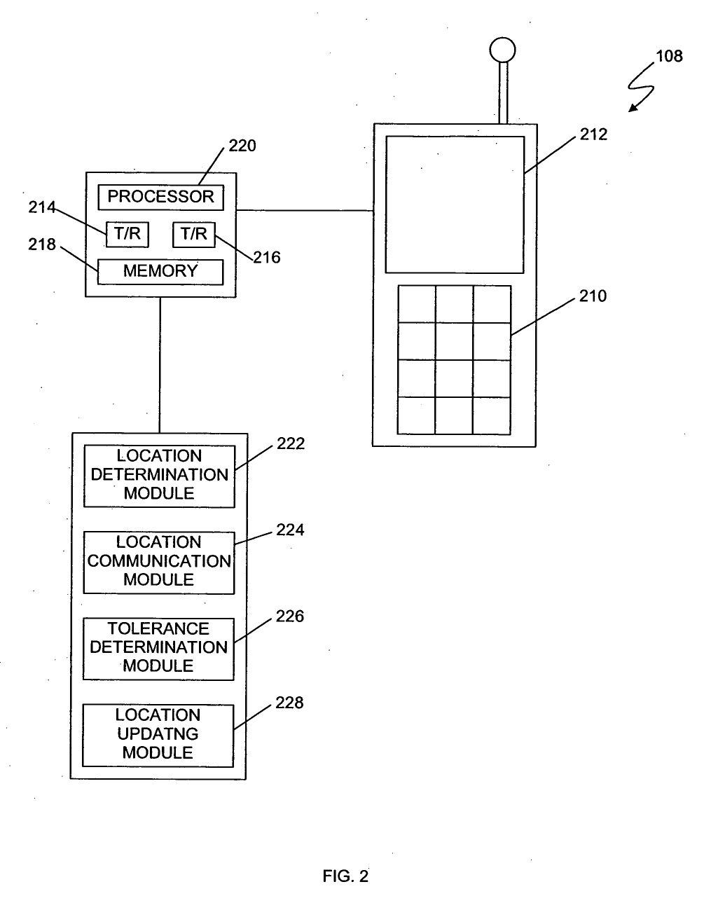

Briefly referring to FIG. 2, there is shown a mobile station 108 and some of its components. The electronic device can include input capability 210 and a display 212. For communication with two different networks that may use different communication protocols such as those specific for a cellular network and a WLAN, the mobile station may include at least a first transceiver 214 and a second transceiver 216. The mobile station may further include a memory 218 and a processor 220 that generally includes one or more modules, which can be implemented in software, such as in the form of one or more sets of prestored instructions, and/or hardware, which facilitate the operation of the mobile station or electronic device as discussed below.

Also shown in FIG. 2 are certain modules that can carry out certain processes of the methods as described herein. They include a location determining module 222, a location communication module 224, a tolerance determination module 226 and a location updating module 228. The functions of these modules and other functions will be discussed in more detail below.

Again referring to FIG. 1, the mobile station 108 is shown in position 110(a). A user may have moved or roamed to position 110(a) that is within the coverage area of the first access point 102. The mobile device may have moved into the coverage area either from inside another coverage area or from outside the access point coverage area. Communication between the access point 102 and the mobile station may be established.

FIG. 1 shows a path 112(a) from position 110(a) to a different position 110(b) that the mobile station 108 may follow. Furthermore, a path 112(b) from position 110(b) is shown to another position 110(c). The paths and positions are intended to show that the mobile station may move in and out of coverage areas for access points 102, 104 and 106. It is understood that any movement of the mobile station from outside a coverage area or from inside any coverage area location to any other coverage area location is within the scope of this discussion.

The access points 102, 104 and 106 are positioned at particular distances 114(a) and 114(b) from each other for example between 100 feet and 200 feet. The actual distances between access points can depend upon the installation of the access points. As mentioned above, the three access points shown may belong to the same WLAN, or may belong to different WLANs. The maximum distance 114(a) and 114(b) may be determined by the technology of the wireless WLAN. For example a wireless LAN operating according to the 802.11a standard can have a maximum distance of several hundred feet. The maximum distance may be technology dependent and can be programmed into the unit 108 at time of manufacture, or may be passed to the unit via a message. In this way a variation of location values between access points may be predetermined.

Also depicted in FIG. 1 is a network provider 116 that may represent, for example, service by a cellular provider or may represent a GPS location service. In any event, the mobile station is capable of receiving location information from the network provider 116 through one of its transceivers 214 or 216 (see FIG. 2). It is further capable of receiving location information from one or more access points 102, 104 or 106 through the other one of its transceivers 214 or 216.

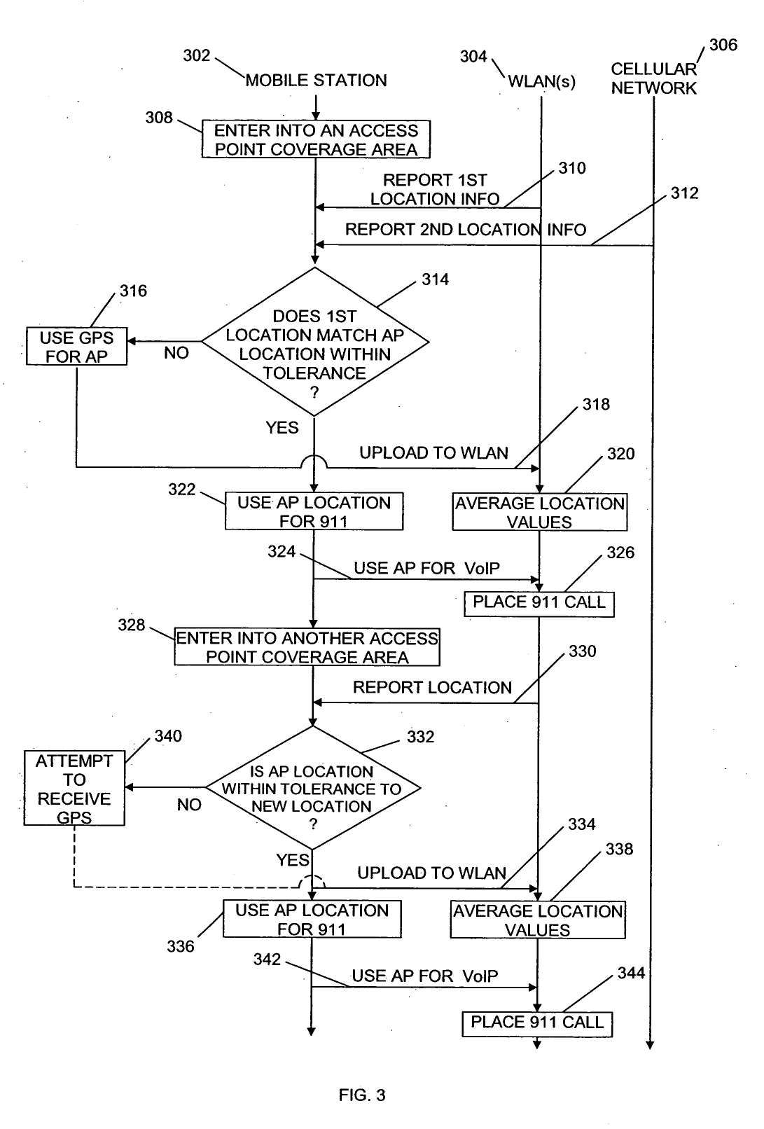

FIG. 3 is a combination signal diagram and flow chart to illustrate communication between and operations of at least one mobile station and a plurality of networks that can include a first network and a second network. The mobile station 302 may be, for example, a cellular telephone. The plurality of networks can include first network 304 which may be one or more WLANs, and a second network 306 which may be a cellular network.

A method of a mobile station for synchronization of location information between the above-described plurality of networks can first include the mobile station 302 entering into the coverage area of an access point of the WLAN 308. The access point can transmit to the mobile station its associated location information 310 provided in a suitable format being a first location value. For synchronization, a second location value can be determined 312. FIG. 3 depicts that the second location value may be provided by a cellular network. However, there are other manners in which to determine the second location value. For example, the mobile station may be GPS enabled itself, or may contain an inertial navigation capability. It is understood that any manner in which the first and second location values are determined or provided are within the scope of this discussion.

As mentioned above, a mobile station may roam in and out of the coverage areas of different access points. The above-described steps of the mobile station 302 entering into the coverage area of an access point of a WLAN 308, can include the situation where the mobile station is moving between coverage areas of different access points as illustrated in FIG. 1. That is, entering into the coverage area of an access point may include leaving the coverage area of a different access point.

The mobile station may synchronize location information by determining if the second location value is within a predetermined tolerance of the first location value 314. The predetermined tolerance, for example, may be based upon the anticipated transmission range of the first access point. In response to the query 314, if the answer is no, then the mobile station can use the second location information associated with the mobile station, determined in conjunction with the second network 316 in the event that a user may make a 911 emergency call.

There may be several reasons that the location information is not within the predetermined tolerance. In one case, the access point may have not reported any information. In that case, the mobile station can upload the second location value to the access point 318.

In another case, the access point may have reported location information exceeding an allowable deviation. In that case, the mobile station may upload the second location value to the access point as well 318. If the access point has received second location values from one or more different mobile stations, it may average those values and use the averaged value as its first location value 320.

In another case, where the comparison is outside the predetermined tolerance, the access point may have reported erroneous location information because it was moved from a previous location to a new location. The mobile station or the access point may determine whether the access point has been moved to a new location. The operational state of the access point may change if it has been moved. Either or both the mobile station and the access point may be adapted to detect whether there has been a change in the access point's operational state. The detection of a change in an operational state may not be treated as movement of the access point if an external indication is received, which is indicative that the access point has not moved.

In another case, wherein the comparison is outside the predetermined tolerance, the operational state of the access point may have changed if it lost power or had a change of IP address. Other reasons for maintaining erroneous location may be considered as well. The access point possibly may therefore accumulate location values uploaded from one or more different mobile stations so it may average those values and use the averaged value as its first location value as shown at 320.

In another embodiment, the mobile device is connected to the access point by a connection that requires a very small distance between the device and the access point, such as Bluetooth link, cabled link, or other appropriate technology. When connected by this short link, the mobile device may supply its location to the access point, and the access point may use the location with a high degree of confidence. The short link GPS measurement may be used without averaging or may receive heavier weighting if averaging is still applied.

Returning to the flowchart element 314, the mobile station may synchronize location information by determining if the second location value is within a predetermined tolerance of the first location value. If the answer is yes, that is, that the second location value is within the predetermined tolerance of the first location value, then the location information associated with the first access point may be used for communication with one or more emergency assistance services, including PSAP 322. The predetermined tolerance may be, for example, between 100 and 200 feet. It is understood that the predetermined tolerance may be a subjective value and for determination by the installer of the WLAN. Or, as mentioned above, it may be determined by the expected transmission range of the access point. Any manner for determining a value for the predetermined tolerance is within the scope of this discussion.

The access point may store the value for the predetermined tolerance and transmit that as well to the mobile station. With the comparison made, there can be a trust but verify process so that the location information retained by the access point is tested. In some circumstances the location value the access point had sent to the mobile may be sent back to the access point, or this feedback could be suppressed. Moreover, an averaging process may be performed if a substantial deviation existed between the first value and the second value but the two values were still within tolerance. The averaging process may be performed in the mobile or in the AP.

Once the access point location value is established in any one or similar ones of the manners described herein, the mobile station may use the access point for communication with one or more emergency assistance services such as a public safety access point (PSAP) 322 as previously mentioned. Accordingly, the methods as described herein include transmitting from the mobile station via the first access point 324, an emergency call including the evaluated location information to one or more emergency assistance services 326.

The mobile station 302 may move from the coverage area of the first access point to a coverage area of a second access point having associated location information including a location value 328. In a manner similar to that described with respect to the first access point, the second access point can communicate to the mobile station the location value of the second access point 330. The mobile station can then determine if the location value of the second access point is within a predetermined variation of the first location value of the first access point 332. A method for establishing the predetermined variation can be based upon the anticipated transmission range of the first access point and the anticipated transmission range of the second access point. If the answer is yes, that is, if the location value of the second access point is within the predetermined variation of the first location value of the first access point, the location value of the second access point can be uploaded to the second access point 334. The mobile station can be preloaded with an expected maximum distance value between access points. The distance can vary with the technology of the access point. Also, the location value of the second access point can be used for one or more emergency assistance services 336. That is, the location information of the mobile station can be updated, so as to correspond to the second access point location value for use by one or more emergency assistance services, while the mobile station is present within the coverage area of the second access point. The values received by the second access point may be averaged including the most recent value transmitted by the mobile station 338.

If as above, with reference to query 314, the answer is no, certain conditions may prevent a positive determination. The mobile device may attempt to receive GPS location information, or location information provided by the cellular network 340. Upon a successful attempt to receive GPS location information, the mobile station may upload the location value to the second access point as shown at 334.

The mobile station may communicate via the access point and may use the access point location for communication with a PSAP. The methods as described herein include transmitting from the mobile station via the second access point 342, an emergency call including the location information used for one or more emergency assistance services 344.

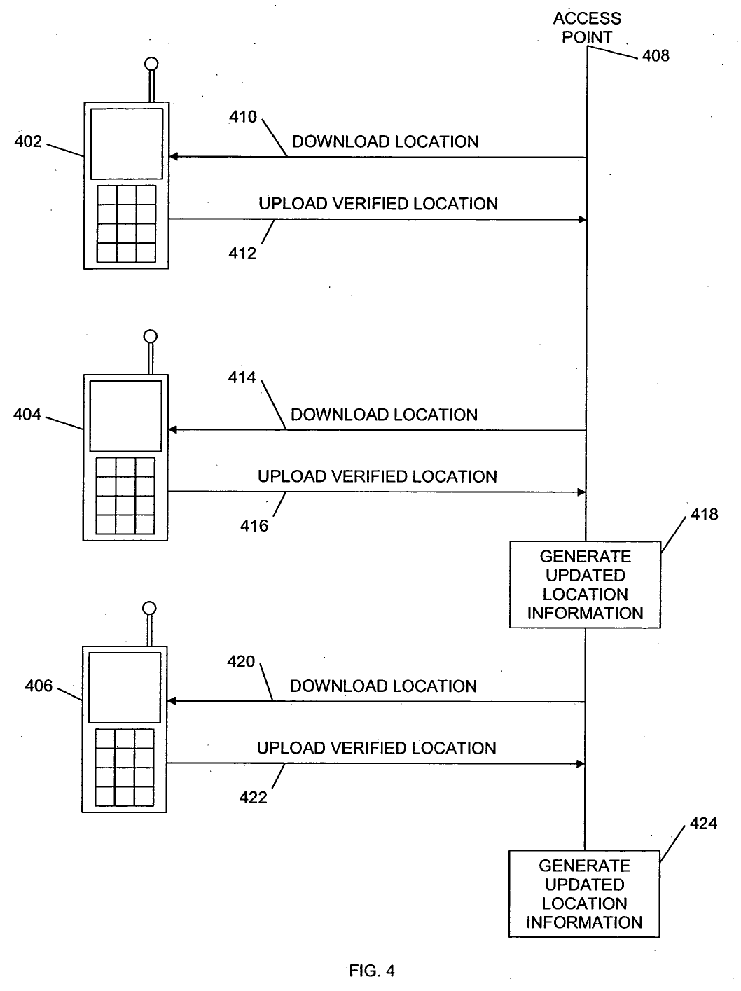

Now turning to FIG. 4, it illustrates a plurality of mobile stations entering into the coverage area of an access point. As discussed above, FIG. 3 illustrates a first mobile station 302 entering the coverage area of the access point. As shown in FIG. 4, further mobile stations 402, 404 and 406 may enter into the coverage area of an access point 408 that can be considered for this discussion the same as an access point of FIG. 3. Each of the mobile stations may carry out the same types of processes that are described with reference to FIG. 3. In particular, mobile station 402 can receive a location value 410 from the access point 408 and then provide a further verified location value 412. Likewise, mobile station 404 can receive a location value 414 from the access point 408 and then provide a further verified location value 416. That is, mobile station 402 and 404 can provide their respective further location values to the access point 408. In this way, the access point can receive respective further location values from each of the further mobile stations and can generate updated location information of the first access point 418, which takes into account the received respective further location values.

Mobile station 406 can receive a location value 420 and can then provide a further verified location value 422. The access point can generate updated location information 424. Generating the updated location information of the access point 408 can include taking into account a predefined number of the most recently received respective further location values. Generating updated location information of the access point can include determining an average of at least some of the received respective further location values.

Moreover, the predefined number may be, for example, ten location values, so that updating can include discarding those that are furthest from the mean location value for the group. Alternatively, generating updated location information of the access point can include excluding any of the received respective further location values in generating the updated location information, which differs from the other non-excluded received respective further location values by more than a predetermined amount.

A mobile station may of course enter into the coverage area of a particular access point more than once. In the event that a mobile station had previously entered into the coverage area of a particular access point, then the mobile station may determine if the received location information is within a predetermined tolerance of any previously received location information relating to that access point. In generating a new location value, the mobile station may compute new location information for the access point taking into account the received location information, and the any previously received location information.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a mobile station for synchronizing location information between a plurality of networks of different types, the method comprising:
entering into the coverage area of a first access point of a first network by the mobile station, the first access point having associated location information including a first location value;
determining a second location information, which is associated with the mobile station, where said second location is not dependent on the first network;
communicating location information between the first access point and the mobile station including receiving the first location value from the first access point by the mobile station;
determining if the second location value is within a predetermined tolerance of the first location value; and
wherein if the second location value is within the predetermined tolerance of the first location value, then using the location information associated with the first access point for one or more services.

2. A method in accordance with claim 1, wherein the predetermined tolerance is based upon the anticipated transmission range of the first access point.

3. A method in accordance with claim 1, wherein if the second location value is outside the predetermined tolerance of the first location value, then using the location information associated with the mobile station for one or more emergency assistance services.

4. A method in accordance with claim 1, further comprising transmitting from the mobile station via the first access point, an emergency call including the location information used for one or more emergency assistance services.

5. A method in accordance with claim 1, wherein if the second location value is outside the predetermined tolerance of the first location value, then transmitting to the first access point of the first network the second location value of the mobile station for use in updating the location information of the first access point.

6. A method in accordance with claim 5, further comprising:
establishing communication between the first network and further one or more mobile stations entering into the coverage area of the first access point of the first network;
receiving respective further location values from each of the further one or more mobile stations; and
generating updated location information of the first access point, which takes into account the received respective further location values.

7. A method in accordance with claim 6, wherein generating updated location information of the first access point includes taking into account a predefined number of the most recently received respective further location values.

8. A method in accordance with claim 6, wherein generating updated location information of the first access point includes determining an average of at least some of the received respective further location values.

9. A method in accordance with claim 6, wherein generating updated location information of the first access point includes excluding any of the received respective further location values in generating the updated location information, which differs from the other non-excluded received respective further location values by more than a predetermined amount.

10. A method in accordance with claim 1, further comprising:
moving by the mobile station from the coverage area of the first access point to a coverage area of a second access point having associated location information including a location value;
communicating location information between the second access point and the mobile station including receiving the location value of the second access point from the second access point by the mobile station;
determining if the location value of the second access point is within a predetermined variation of the first location value of the first access point; and
wherein if the location value of the second access point is within the predetermined variation of the first location value of the first access point, then using the location value of the second access point for one or more services.

11. A method in accordance with claim 10, wherein the predetermined variation is determined based upon the anticipated transmission range of the first access point and the anticipated transmission range of the second access point.

12. A method in accordance with claim 1, wherein the first network is a wireless local area network.

13. A method in accordance with claim 1, wherein the service includes emergency assistance service.

14. A method in accordance with claim 1, wherein the second location information is determined by a global positioning system.

15. A method of synchronizing location information between a plurality of networks of different types, the plurality of networks including a first network including an access point having a coverage area, and a second network including one or more mobile stations adapted for communicating with both the first network and the second network, the method comprising:
receiving location information by the access point from one or more mobile stations, which enter the coverage area of the access point; and
computing new location information for the access point taking into account the received location information, and the any previously received location information.

16. A method in accordance with claim 15, the method further comprising the step of determining if the received location information is within a predetermined tolerance of any previously received location information; and computing new location information if the received location information is within the predetermined tolerance.

17. A method in accordance with claim 15, the method further comprising:
determining if the access point is moved to a new location; and
wherein if the access point is moved, then discarding any previously received location information.

18. A method in accordance with claim 17, wherein determining if the access point is moved includes detecting a change in the operational state.

19. A method in accordance with claim 18, wherein a change in the operational state includes an interruption in the power supplied from an external source.

20. A method in accordance with claim 17, wherein the detection of a change in an operational state will not be treated as movement of the access point if an external indication is received, which is indicative that the access point has not moved.

21. A method for tracking location of a mobile station within a first network from the coverage area of a first access point into the coverage area of a second access point, comprising:
communicating between the mobile station and the first access point a first access point location value of the first access point for use as location information of the mobile station, while within a coverage area of the first access. point;
moving from the coverage area of the first access point to the coverage area of the second access point;
communicating between the mobile station and the second access point a second access point location value of the second access point;
determining if the second access point location value is within a predetermined variation of the first access point location value; and
wherein if the second access point location value is within the predetermined variation of the first access point location value,. then updating the location information of the mobile station, so as to correspond to the second access point location value for use by one or more services, while present within the coverage area of the second access point.

22. A method of an access point and a mobile station, the mobile station capable of determining location information, the method comprising:
establishing a connection between the mobile station and the access point; and
providing by the mobile station the location information to the access point when the mobile station and the access point are separated by less than approximately fifty feet.
